(19) United States
(12) Patent Application Publication
(10) Pub. No.: US 2004/0017032 A1
(43) Pub. Date: Jan. 29, 2004

(54) Vibration damper

(75) Inventor: Udo Goebel, Neuenburg (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 10/457,292

(22) Filed: Jun. 9, 2003

(30) Foreign Application Priority Data
Jun. 10, 2002 (DE) DE 102 25 586.5

(51) Int. Cl. F16F 5/00

(52) U.S. Cl. 267/140.11

(57) ABSTRACT

A vibration damper connected to a vibrating machine part and including a vibrating mass base element and a plurality of vibrating elements connected to the vibrating mass base element. The vibrating mass base element is connectable to the vibrating machine part via the plurality of vibrating elements.

Priority is claimed to German Patent Application DE 102 25 586.5, filed on Jun. 10, 2002, which is incorporated by reference herein.

### BACKGROUND INFORMATION

The present invention relates to a vibration damper connected to a vibrating machine part.

In technology, the use of vibration dampers is widespread. A distinction is drawn between linear-acting vibration dampers, which are manufactured in different forms and which act on a spatially fixed vibration direction, and rotating vibration dampers, which act on torsional vibrations and flexural vibrations of rotating shafts. For example, linear-acting vibration dampers may be used for damping the vibrations on the body of a vehicle, on the vehicle subframe, or on the engine-transmission block. They should have an optimal damping coefficient and should feature high frequency stability. The vibration dampers are tuned to the interfering frequency and protect against vibrations, noises, and damages due to material breakage.

The linear-acting vibration dampers used today are typically formed of a metallic vibrating mass, which is connected to the machine part to be damped via a rubber track. This also includes transmission dampers, which are mounted on the transmission housing via an engine-transmission unit. They have an opening in the center, which encloses the cardan shaft. These vibration dampers have a substantial weight and are manufactured in an expensive manufacturing process. Their physical dimensions frequently interfere with the assembly of the cardan shaft.

### SUMMARY OF THE INVENTION

An object of the present invention is to provide a vibration damper which is manufacturable in a simple manner, and which is advantageous with regard to assembly.

The present invention provides a vibration damper, in particular on transmissions for motor vehicle engines for damping the vibrations of the transmission block in an engine-transmission unit which is connected to the vibrating machine part, in that the engine-transmission unit has a vibrating mass base element which is connectable to the vibrating machine part via at least two vibrating elements which are detachably connected to the vibrating mass base element. The vibrating mass base element and the vibrating elements may be connected in different ways; a detachable connection, e.g., a bolted connection, is preferred.

The vibrating elements are each formed of a holding plate and a vibrating mass plate which are connected to one another via an elastic spring part. An elastomer is preferably used as the spring part, which is frequently referred to as a rubber track.

An advantage achievable regarding manufacturing lies in the fact that the vibrating elements may be manufactured separately from the vibrating mass base element. The heavy and relatively large vibrating mass base element does not have to be carried through the entire manufacturing process. The vibrating mass base element and the appropriate vibrating elements are each manufactured separately and are joined with one another to form a single component only after their manufacture. During manufacture, the vibrating mass base element is thus separated, which makes a simpler use of the vulcanization tool for the vibrating elements achievable. In addition, lower pre-heating is required for the vulcanization process and binders are saved. In different vehicle types having the same or similar engine-transmission units, there is also the possibility of utilizing the same vibrating elements, and of merely adapting the vibrating mass base element to the prevailing assembly space conditions. Among other things, this also reduces the spare parts inventory.

The vibration damper is preferably designed such that the vibrating elements of a specific vibration damper have an identical shape. Among other things, this has the advantage that they may be mounted both on the left side and on the right side. Mix-ups are not possible. It is advantageous here if the vibrating elements have the shape of cylindrical arc segments. The arc ends of the vibrating elements are mounted with a space between them. Recesses on the damper itself may thus be achieved, both on the damper top side and the damper bottom side, which may be an advantage during assembly of the cardan shaft or its maintenance. It is also possible for example to assemble the cardan shaft after mounting the damper on the transmission since the mounting bolts are accessible through the recess on the damper top side. During repair work in a repair shop, the recess on the damper bottom side allows the dismantling of the cardan shaft without unscrewing the vibration damper.

Both the holding plate and the vibrating mass plate of the vibrating element have holes for receiving the mounting bolts. These holes are located on arcs of circumference having an identical diameter. As mentioned above, this facilitates the versatile mounting possibility of the vibrating elements on the vibrating mass base element and ultimately also of the entire vibration damper on the transmission.

### BRIEF DESCRIPTION OF THE DRAWINGS

The present invention is explained in greater detail in the following, based upon the exemplary embodiment illustrated in the drawings, in which:

FIG. 1 shows a top view of the vibration damper;

FIG. 2 shows a section through the vibration damper in FIG. 1 along line B-B;

FIG. 3 shows a top view of a vibration damper; and

FIG. 4 shows a section through the vibration damper in FIG. 3 along line A-A.

### DETAILED DESCRIPTION

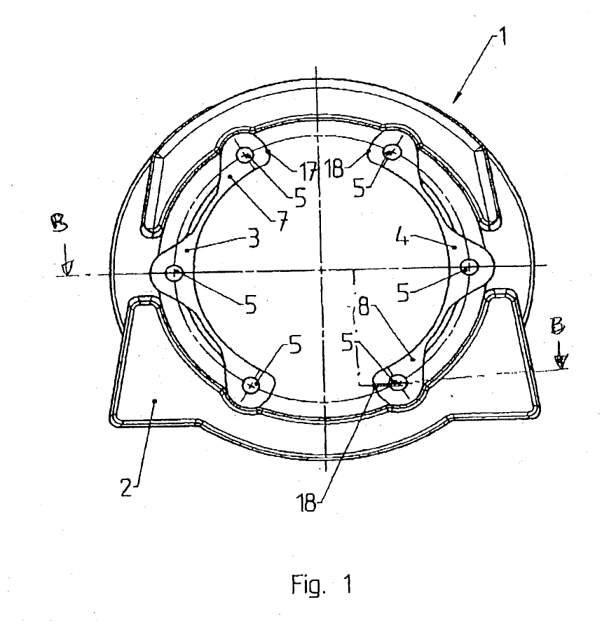

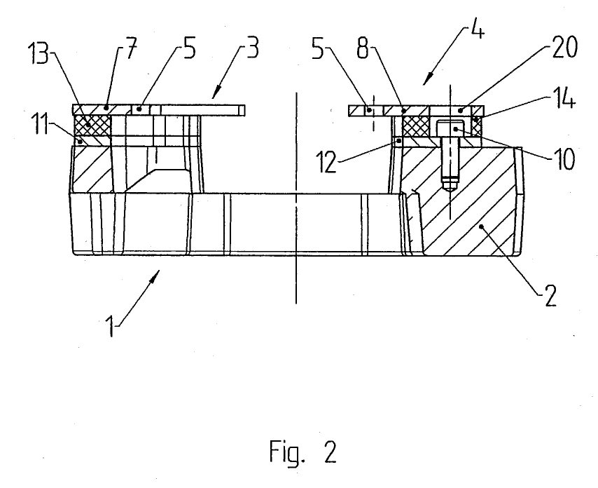

FIG. 1 shows a top view of vibration damper 1 having vibrating mass base element 2 and two vibrating elements 3 and 4. Via holes 5 in holding plates 7 and 8 of vibrating elements 3 and 4 evenly spread out over the circumference of vibration damper 1, vibration damper 1 is bolted to a machine part (not shown in detail). Vibrating mass base element 2 is connected to vibrating elements 3 and 4 via bolts 10, visible in FIG. 2. The design of vibrating mass base element 2 depends on both the existing assembly space and the vibrations occurring during operation.

FIG. 2 shows a section through FIG. 1 along line B-B. The three-part structure of vibrating elements 3, 4, including holding plates 7, 8, vibrating mass plates 11 and 12, as well as elastic spring parts 13 and 14, is visible here. Holding plates 7, 8, as well as vibrating mass plates 11 and 12 are connected by vulcanization via elastic spring parts 13 and 14. Vibration damper 1 is mounted on a machine part using bolts which are inserted through holes 5. Holes 5 are situated in holding plates 7 and 8. Vibrating mass base element 2 is attached to vibrating elements 3 and 4 using bolts 10 which are inserted through corresponding holes of vibrating mass plates 111 and 12.

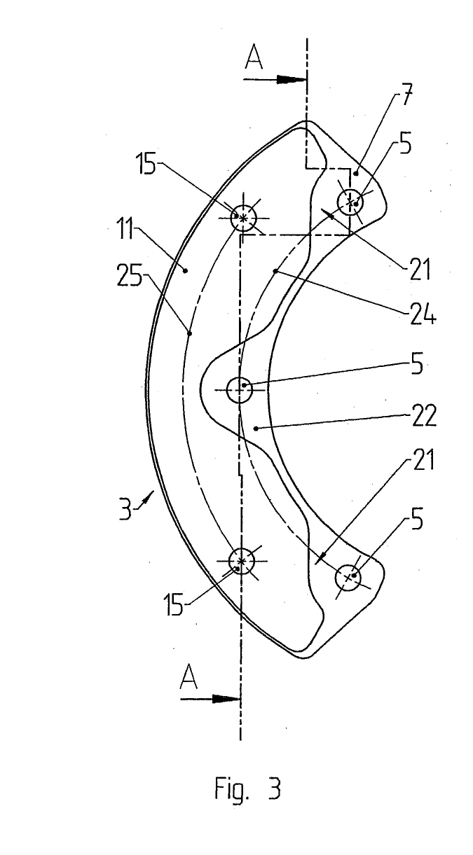

A top view of a vibrating element is shown separately in FIG. 3. Elastic spring part 13 is attached between holding plate 7 and vibrating mass plate 11; holes 15 for mounting bolts 10 used for mounting vibrating mass base element 2 on vibrating mass plate 11 are also visible here. Vibrating elements 3 and 4 for a vibration damper 1 have the same design. The shape of cylindrical arc segments is selected in the example; arc ends 17 and 18 of corresponding vibrating elements 3 and 4 are situated at a distance from one another. In this way, as can be seen in FIG. 2 in particular, an opening between vibrating elements 3 and 4 occurs which is delimited in the axial direction by the machine part on which vibration damper 1 is mounted, and vibrating mass base element 2. This creates openings on the top and bottom of vibration damper 1 which, in the engine-transmission unit, allow access to the cardan shaft using appropriate tools; these recesses may be enlarged, if, as shown in the present example, vibrating mass base element 2 is also provided with recesses in the axial direction.

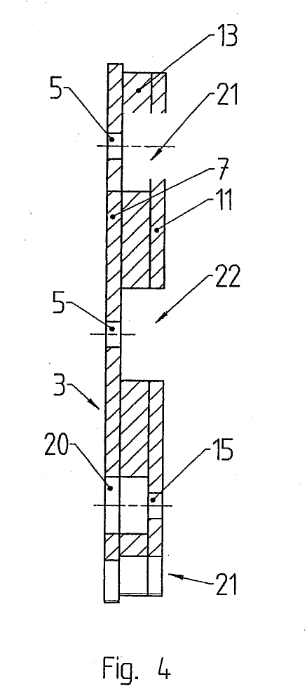

FIG. 4 shows a section through FIG. 3 along line A-A. Holding plate 7 has holes 5 for mounting on the vibrating machine part. In addition, the holding plate is provided with holes 20 for inserting bolts 10. Vibrating mass plate 111 has holes 15 for attachment to vibrating mass base element 2 and provides access to holes 5 via dents 21 and 22. Holding plate 7 and vibrating mass plate 11 are connected with one another by vulcanization via the rubber track, i.e., elastic spring part 13.

During the manufacture of vibration damper 1, vibrating elements 3 and 4 are initially manufactured by stamping out holding plates 7 and vibrating mass plates 11. Both plates, together with inserted spring parts 13 and 14, are subsequently connected with one another. Then, vibrating mass base element 2 is bolted to holding plate 7 or 8. Vibration damper 1, completed in this way, is then connected to the vibrating machine part at the desired location.

It is advantageous if vibrating elements 3 and 4 have the same design, so that they may be mounted on both the left side and the right side. For this purpose, holes 5 and 15 are situated on circumferences 24 and 25, evenly spaced to one another for each vibrating element 3 or 4.

What is claimed is:

1. A vibration damper connected to a vibrating machine part, the vibration damper comprising:
a vibrating mass base element
a plurality of vibrating elements connected to the vibrating mass base element, the vibrating mass base element connectable to the vibrating machine part via the plurality of vibrating elements.

2. The vibration damper as recited in claim 1 wherein the vibrating machine part is a transmission of a motor vehicle and the vibration damper is for damping vibrations of a transmission block in an engine-transmission unit of the motor vehicle.

3. The vibration damper as recited in claim 1 wherein the vibrating mass base element is detachably connected to the plurality of vibrating elements.

4. The vibration damper as recited in claim 1 wherein each of the plurality of vibrating elements include a holding plate, a vibrating mass plate and an elastic spring part, the holding plate connected to the vibrating mass plate via the elastic spring part.

5. The vibration damper as recited in claim 4 wherein the vibrating mass base element is connected to at least one of the vibrating mass plates.

6. The vibration damper as recited in claim 4 wherein each of the plurality of vibrating elements are connected to the vibrating machine part via the respective holding plate.

7. The vibration damper as recited in claim 1 wherein each of the plurality of vibrating elements have an identical shape.

8. The vibration damper as recited in claim 1 wherein each of the plurality of vibrating elements have a shape of a cylindrical arc segment.

9. The vibration damper as recited in claim 8 wherein ends of each cylindrical are attached at a distance from one another.

10. The vibration damper as recited in claim 4 wherein each of the holding plates and the vibrating mass plates include a hole for receiving a mounting bolts.

11. The vibration damper as recited in claim 10 wherein each of the holes has an hole axis intersecting with a single arc of circumference of the vibration damper.

12. The vibration damper as recited in claim 1 wherein a mass of the vibrating mass base element is a multiple of a mass of the vibrating mass plate.
